(19) United States
(12) Patent Application Publication
(10) Pub. No.: US 2026/0230704 A1
(43) Pub. Date: Aug. 6, 2026

(54) DETECTION SYSTEM

(71) Applicant: Japan Display Inc., Tokyo (JP)

(72) Inventor: Junior JUAN OSCAR, Tokyo (JP)

(21) Appl. No.: 19/463,837

(22) Filed: Jan. 29, 2026

(30) Foreign Application Priority Data
Jan. 31, 2025 (JP) 2025-015049

(51) Int. Cl. H04N 23/66; H04N 23/62

(52) U.S. Cl. CPC H04N 23/66; H04N 23/62

(57) ABSTRACT

According to an aspect, a detection system includes a detection device and an information processing device. The detection device includes: a sensor panel on which optical sensors are two-dimensionally arranged; a light source panel provided with a light source configured to emit light; an object placement member provided to enable an object to be detected to be placed thereon so that the object to be detected is interposed between the sensor panel and the light source panel; and a controller provided with a circuit that is coupled to the sensor panel and the light source panel, and configured to control operations of the sensor panel and the light source panel. The controller is coupled to the information processing device via a Universal Serial Bus (USB) (registered trademark). Power supply to the detection device and communication between the information processing device and the controller are performed via a USB-based coupling.

### CROSS-REFERENCE TO RELATED APPLICATION

This application claims the benefit of priority from Japanese Patent Application No. 2025-015049 filed on January 31, 2025, the entire contents of which are incorporated herein by reference.

### BACKGROUND

### Technical Field

What is disclosed herein relates to a detection system.

### Description of the Related Art

Detection devices are known that enable detection of states of culture environments for culturing biological tissues or microorganisms using an optical sensor (for example, Japanese Patent Application Laid-open Publication No. 2005-087005).

In each of the conventional detection devices, communication cables for transmitting data obtained correspondingly to the output of the optical sensor to external equipment and a power supply cable for transmitting power to operate the detection device are separately provided. Therefore, the coupling form between the detection device and external components is complicated due to the multiple cables coupled to the detection device, which reduces the ease of arrangement of the detection device.

For the foregoing reasons, there is a need for a detection system having a simpler form of cables provided for supplying power to and communicating with a detection device.

### SUMMARY

According to an aspect, a detection system includes a detection device and an information processing device. The detection device includes: a sensor panel on which a plurality of optical sensors are two-dimensionally arranged; a light source panel provided with a light source configured to emit light; an object placement member provided to enable an object to be detected to be placed thereon so that the object to be detected is interposed between the sensor panel and the light source panel; and a controller provided with a circuit that is coupled to the sensor panel and the light source panel, and configured to control operations of the sensor panel and the light source panel. The controller is coupled to the information processing device via a Universal Serial Bus (USB) (registered trademark). Power supply to the detection device and communication between the information processing device and the controller are performed via a coupling based on the USB.

### BRIEF DESCRIPTION OF THE DRAWINGS

FIG. 1 is a diagram illustrating a main configuration of a detection system;

FIG. 2 is a diagram illustrating a configuration example of a detection area and a wiring area;

FIG. 3 is a circuit diagram illustrating a circuit configuration of an optical sensor;

FIG. 4 is a schematic view illustrating a positional relation of main components of a detection device with an object to be detected;

FIG. 5 is a block diagram illustrating a configuration example of the detection system;

FIG. 6 is a view illustrating an example of display output provided by a display of an information processing device executing application software;

FIG. 7 is a diagram illustrating transition of the display output of a small window and an example of the display output of a detail window that is displayed in response to an operation on an "Info" button in an imaging operation state;

FIG. 8 is a diagram illustrating the display output in a standby state and an example of the display output of the detail window that is displayed in response to the operation on the "Info" button in a standby state;

FIG. 9 is a diagram illustrating the display output in an error state and an example of the display output of the detail window that is displayed in response to the operation on the "Info" button in the error state;

FIG. 10 is a flowchart of processing performed since the information processing device and a controller start operating until communication is established between the information processing device and the controller;

FIG. 11 is a flowchart of processing performed in response to an operation on a "Start" button while the communication is established between the information processing device and the controller;

FIG. 12 is a flowchart of an imaging operation performed by the controller and an imaging data acquisition operation performed by the information processing device;

FIG. 13 is a flowchart of processing performed in response to an operation on a "Disconnect" button while the communication is established between the information processing device and the controller; and

FIG. 14 is a flowchart illustrating processing performed in response to the operation on the "Info" button while the communication is established between the information processing device and the controller.

### DETAILED DESCRIPTION

The following describes an embodiment of the present disclosure with reference to the drawings. What is disclosed herein is merely an example, and the present disclosure naturally encompasses appropriate modifications easily conceivable by those skilled in the art while maintaining the gist of the present invention. To further clarify the description, the drawings may schematically illustrate, for example, widths, thicknesses, and shapes of various parts as compared with actual aspects thereof. However, they are merely examples, and interpretation of the present disclosure is not limited thereto. The same element as that illustrated in a drawing that has already been discussed is denoted by the same reference numeral through the description and the drawings, and detailed description thereof may not be repeated where appropriate.

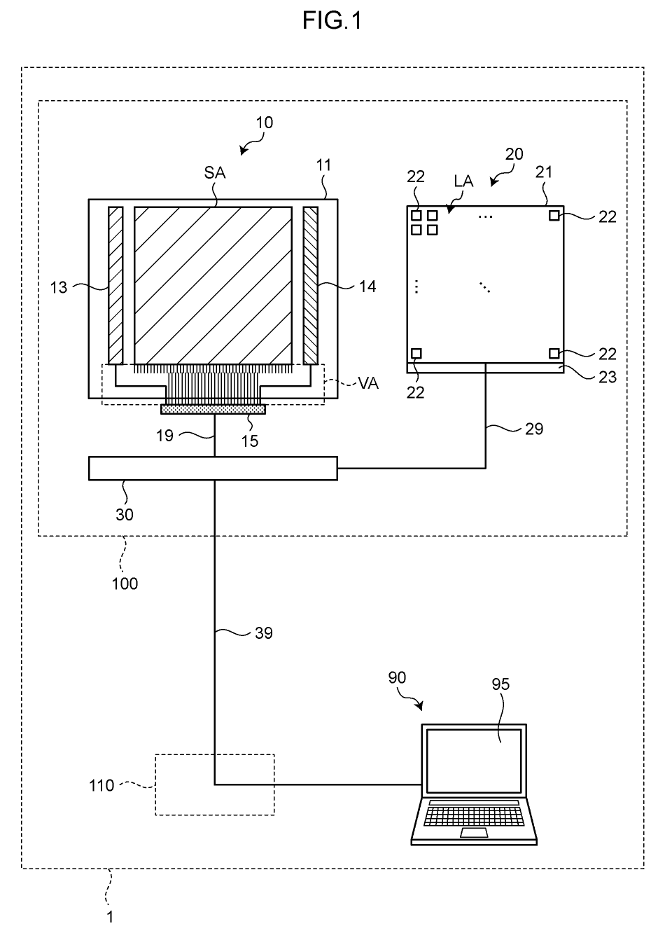

FIG. 1 is a diagram illustrating a main configuration of a detection system 1. The detection system 1 includes a detection device 100 and a host computer 90. The detection device 100 includes a sensor panel 10, a light source panel 20, and a microcontroller unit (MCU) 30. The sensor panel 10 and the light source panel 20 of the detection device 100 are coupled to the MCU 30.

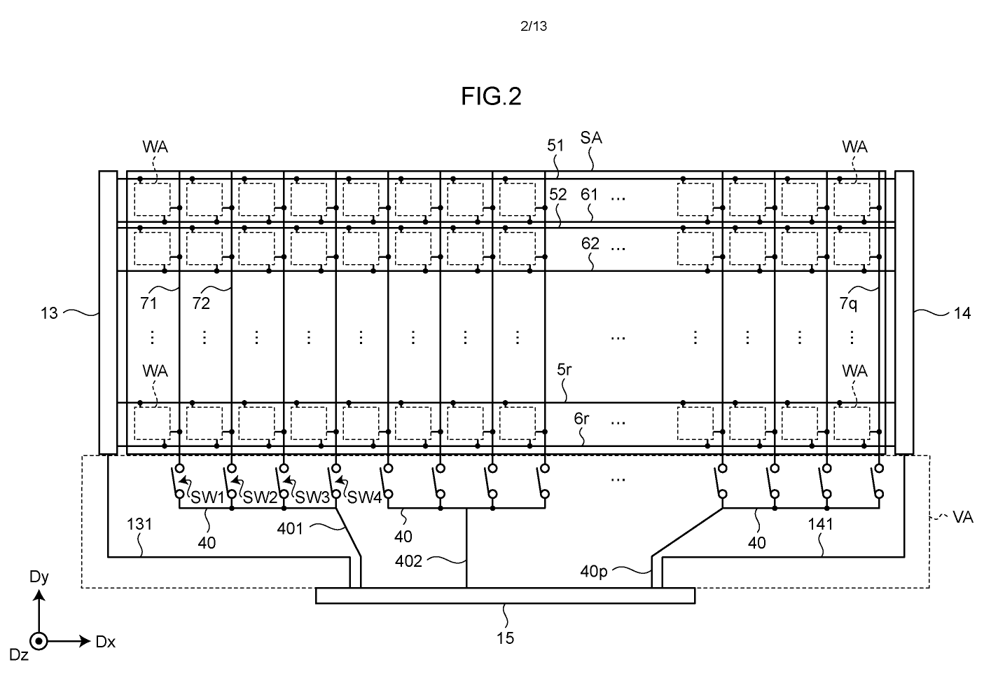

The sensor panel 10 is provided with a detection area SA (refer to FIG. 2) on a substrate 11. A reset circuit 13, a scan circuit 14, and a wiring area VA are mounted on the substrate 11. Components on the detection area SA, the reset circuit 13, and the scan circuit 14 are coupled to a detection circuit 15 via the wiring area VA.

The light source panel 20 has a light-emitting area LA that emits light to the detection area SA. The light source panel 20 is provided with a light source 22 on a substrate 21. The light source 22 includes a light-emitting element, such as a light-emitting diode (LED), and is provided in the light-emitting area LA. In the example illustrated in FIG. 1, a plurality of the light sources 22 are arranged in a matrix having a row-column configuration on the substrate 21.

The light source panel 20 is provided with a light source drive circuit 23. Under the control of the MCU 30, the light source drive circuit 23 controls turning on and off each of the light sources 22 and the luminance thereof when being turned on. The light sources 22 may be provided to allow individual control of light emission or may be provided so as to emit light collectively.

The MCU 30 is a microcontroller unit (MCU) that performs various processes related to operations of the detection device 100. The MCU 30 is coupled to the detection circuit 15 via wiring 19 and obtains outputs from the detection circuit 15. The MCU 30 is also coupled to the light source drive circuit 23 via wiring 29, and performs processes related to the lighting of the light sources 22, such as determination of lighting patterns of the light sources 22.

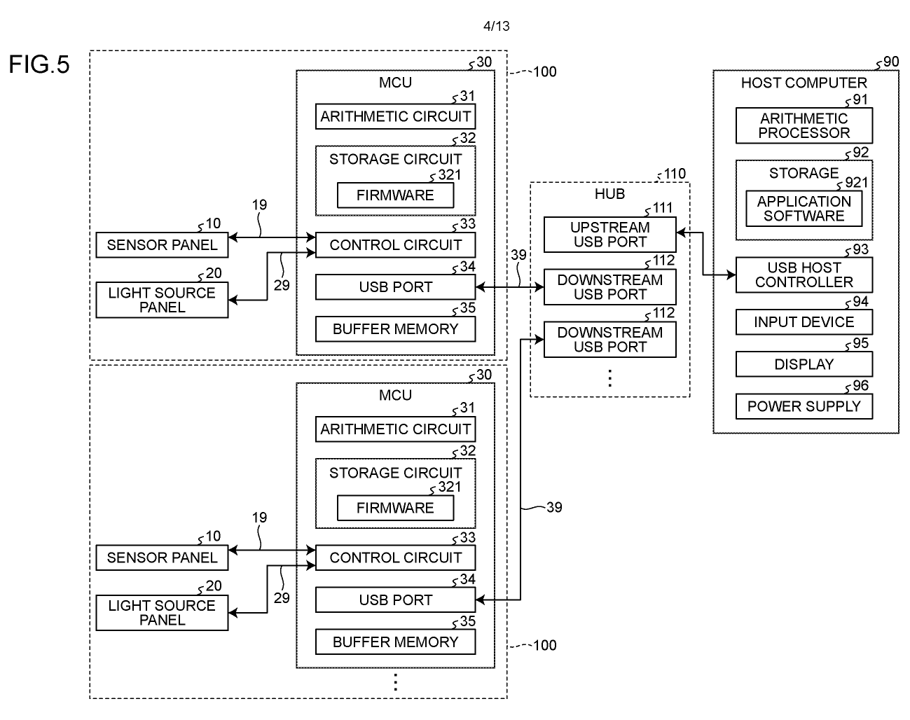

The MCU 30 is coupled via Universal Serial Bus (USB) (registered trademark) to the host computer 90 that includes a display 95. The phrase "coupled via USB" refers to that a USB port 34 included in the MCU 30 is coupled to a USB port of a USB host controller 93 included in the information processing device 90, using a USB cable 39 (refer to FIG. 5). In FIGS. 1 and 5, a hub 110 is interposed between the MCU 30 and the host computer 90, but the hub 110 can be omitted. The MCU 30 may be directly coupled to the host computer 90 by the USB cable 39.

Although not illustrated in the drawings, the detection device 100 includes an analog-to-digital conversion circuit, a digital-to-analog conversion circuit, and other components. The analog-to-digital conversion circuit allows an output from an optical sensor WA (refer to FIG. 2) transmitted via the detection circuit 15 to be handled by arithmetic processing by the MCU 30. The digital-to-analog conversion circuit makes digital signals generated by the arithmetic processing of the MCU 30 usable for controlling operations of the sensor panel 10 and the light source panel 20. These circuits may be included, for example, in part or in whole in the MCU 30. These circuits may alternatively be functions performed by circuits mounted on flexible printed circuits (FPCs) provided as the wiring 19 and the wiring 29. These circuits may alternatively be mounted in other ways on the detection device 100.

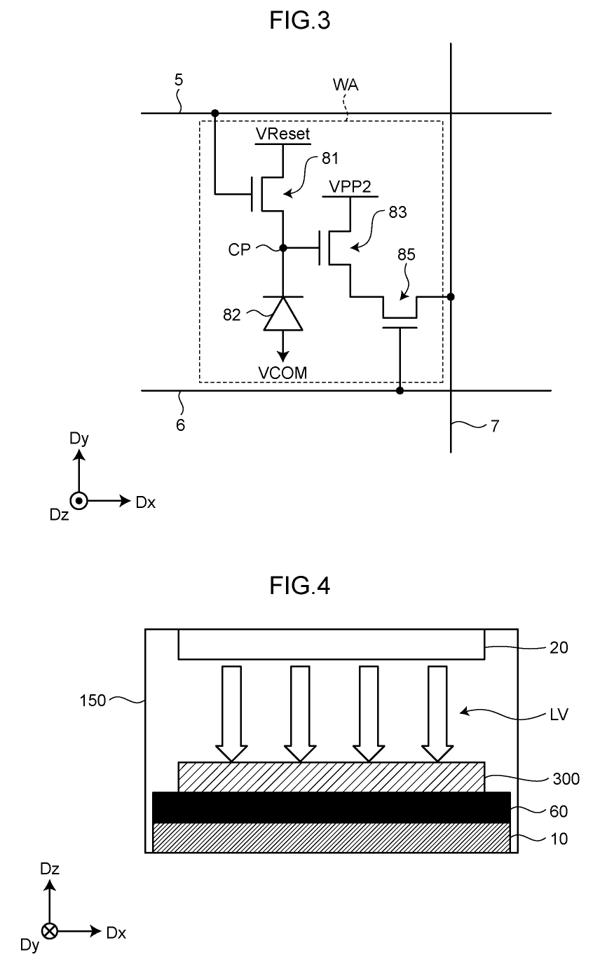

FIG. 2 is a diagram illustrating a configuration example of the detection area SA and the wiring area VA. A plurality of the optical sensors WA (FIG. 3) are provided in the detection area SA of the sensor panel 10. In the embodiment, as illustrated in FIG. 2, the optical sensors WA are arranged in a matrix having a row-column configuration along a first direction Dx and a second direction Dy. The first direction Dx is orthogonal to the second direction Dy. In the following description, the "third direction Dz" refers to a direction orthogonal to the first direction Dx and the second direction Dy.

The reset circuit 13 is coupled to reset signal transmission lines 51, 52, ..., 5r. Hereinafter, the "reset signal transmission line 5" refers to any one of the reset signal transmission lines 51, 52, ..., 5r. The reset signal transmission line 5 is wiring along the first direction Dx. In the example illustrated in FIG. 2, r reset signal transmission lines 5 are arranged in the second direction Dy. r is a natural number equal to or larger than 2. The r reset signal transmission lines 5 are each coupled, at one end in the first direction Dx, to the reset circuit 13.

The scan circuit 14 is coupled to scan lines 61, 62, ..., 6r. Hereinafter, the "scan line 6" refers to any one of the scan lines 61, 62, ..., 6r. The scan line 6 is wiring along the first direction Dx. In the example illustrated in FIG. 2, r scan lines 6 are arranged in the second direction Dy. The r scan lines 6 are each coupled, at the other end in the first direction Dx, to the scan circuit 14.

As illustrated in FIG. 2, the reset signal transmission lines 5 and the scan lines 6 are alternately arranged in the second direction Dy in the detection area SA. The reset circuit 13 and the scan circuit 14 illustrated in FIGS. 1 and 2 are arranged at locations facing each other with the detection area SA interposed therebetween, but the layout of the reset circuit 13 and the scan circuit 14 is not limited to this layout and can be changed as appropriate.

Signal lines 71, 72, ..., 7q are also provided in the detection area SA. Hereinafter, the "signal line 7" refers to any one of the signal lines 71, 72, ..., 7q. The signal line 7 is wiring along the second direction Dy.

In the example illustrated in FIG. 2, q signal lines 7 are arranged in the first direction Dx. q is a natural number equal to or larger than 2. The q signal lines 7 are each coupled, at one end in the second direction Dy, to one of a plurality of switches (for example, a switch SW1, SW2, SW3, or SW4) included in a multiplexer 40.

The multiplexer 40 is provided in the wiring area VA. The multiplexer 40 includes a plurality of switches. In the example illustrated in FIG. 2, the switches SW1, SW2, SW3, and SW4 are illustrated as the switches. The switches included in one multiplexer 40 are turned on (conducting state) at different times from one another. During a period when one of the switches included in one multiplexer 40 is on (conducting state), the other switches are off (non-conducting state). The number of the multiplexers 40 depends on the number (q) of the signal lines 7. When the number of the switches is p, q/p is sufficient as the number of the multiplexers 40. When more than one multiplexer 40 are provided, each of the multiplexers 40 is coupled to the detection circuit 15 via an individual one of wiring lines 401, 402, ..., 40p.

The coupling between the signal lines 7 and the detection circuit 15 via the multiplexer 40 is merely exemplary and is not limited to this example. The signal lines 7 may be individually directly coupled to the detection circuit 15 in the wiring area VA. In the wiring area VA, the reset circuit 13 is coupled to the detection circuit 15 via wiring 131. In the wiring area VA, the scan circuit 14 is coupled to the detection circuit 15 via wiring 141.

In detecting light using a PD 82 (refer to FIG. 3) provided in the optical sensor WA, the detection circuit 15 controls operation timing of the reset circuit 13 and the scan circuit 14. The detection circuit 15 receives an output from the optical sensor WA. The detection circuit 15 converts the signals received from the optical sensors WA into data that can be interpreted by the MCU 30 and outputs the data to the MCU 30.

FIG. 3 is a circuit diagram illustrating a circuit configuration of the optical sensor WA. The first direction Dx and the second direction Dy in FIG. 3 merely correspond to the directions of the reset signal transmission lines 5, the scan lines 6, and the signal lines 7, and do not exactly indicate the relative positional relation of the circuit configuration in the optical sensor WA.

As illustrated in FIG. 3, a switching element 81, the PD 82, a transistor element 83, and a switching element 85 are provided in the optical sensor WA. The PD 82 is a photodiode (PD). The switching elements 81 and 85 and the transistor element are metal-oxide semiconductor field-effect transistors (MOSFETs).

The gate of the switching element 81 is coupled to the reset signal transmission line 5. One of the source and the drain of the switching element 81 is supplied with a reset potential VReset. The other of the source and the drain of the switching element 81 is coupled to the cathode of the PD 82 and the gate of transistor element 83. Hereinafter, the "coupling part CP" refers to a point where the other of the source and the drain of the switching element 81 is coupled to the cathode of the PD 82 and the gate of transistor element 83. A reference potential VCOM is given from the anode side of the PD 82. The potential difference between the reset potential VReset and the reference potential VCOM is set in advance, but the reset potential VReset and the reference potential VCOM may be variable. The reset potential VReset is higher than the reference potential VCOM.

The drain of the transistor element 83 serving as a source follower is supplied with a potential VPP2. The source of the transistor element 83 is coupled to one of the sources and the drain of the switching element 85. The other of the source and the drain of the switching element 85 is coupled to the signal line 7. The gate of the switching element 85 is coupled to the scan line 6.

The reset potential VReset, the reference potential VCOM, and the potential VPP2 are supplied by the detection circuit 15 to the optical sensor WA based on, for example, electric power supplied via a power supply circuit (not illustrated) coupled to the detection circuit 15 but are not limited to being supplied in this way and may be supplied in a different way as appropriate.

The potential VPP2 is set in advance. The potential on the source side of the transistor element 83 is a potential lower than the output potential of the PD 82 by a voltage (Vth) between the gate and the source of the transistor element 83. In this case, the potential on the source side of the transistor element 83 corresponds to the reset potential VReset and the reference potential VCOM. The potential of the output of the PD 82 corresponds to photovoltaic power generated by the PD 82 according to the light detected by the PD 82 during an exposure period.

When the gate of the switching element 85 is turned on by a signal given from the scan circuit 14 via the scan line 6, the source and the drain of the switching element 85 are brought into a conducting state therebetween. As a result, a signal (potential) transmitted via the transistor element 83 to the switching element 85 is transmitted to the signal line 7 via the switching element 85. Thus, the output from the optical sensor WA is generated. Hereinafter, the "scan signal" refers to the signal (potential) given from the scan circuit 14 via the scan line 6. The scan circuit 14 is a circuit that outputs the scan signal.

The output of one PD 82 provided in one optical sensor WA corresponds to the intensity of the light detected by the PD 82 during the exposure period set in advance. The output of the PD 82 is reset in response to a signal given by the reset circuit 13 via the reset signal transmission line 5. When the signal turns on the gate of the switching element 81, the source and the drain of the switching element 81 are brought into a conducting state therebetween. This operation resets the potential of the coupling part CP to the reset potential VReset.

FIG. 4 is a schematic view illustrating a positional relation of main components of the detection device 100 with an object to be detected 300. When the object to be detected 300 is placed between the sensor panel 10 and the light source panel 20, the object to be detected 300 is placed on a member 60, for example, as illustrated in FIG. 4. The member 60 serves as an object placement member on which the object to be detected 300 can be placed so that the object to be detected 300 is interposed between the detection area SA and the light source panel 20.

In the embodiment, the sensor panel 10 is located below the object to be detected 300 and the light source panel 20 is located above the object to be detected 300, as illustrated in FIG. 4. The member 60 of the embodiment also serves as an optical member that limits the light that is emitted from the light sources 22 of the light source panel 20 and reaches the sensor panel 10. Specifically, the member 60 includes any of a plate-shaped louver, cylindrical openings, and microlenses. In the plate-shaped louver, a plurality of plate-like structures with plate surfaces extending along the third direction Dz are arranged in parallel. The structures are preferably made of a material having a strong light-absorbing property. The member 60 is provided along a plane (Dx-Dy plane) orthogonal to the third direction Dz. The cylindrical openings penetrate the member 60 in the third direction Dz with respect to the base of the member 60. The base is preferably made of a material having a strong light-absorbing property. The microlenses are small lenses having an optical axis along the third direction Dz. The base of the member 60 that supports the microlenses is preferably made of a material having a strong light-absorbing property. The member 60 as the optical member is provided in order to limit the direction of travel of the light emitted from the light sources 22 and reaching the sensor panel 10 to the third direction Dz or a direction having a shallower inclination angle with respect to the third direction Dz.

In the embodiment, the member 60 serves as both the optical member and a member on which the object to be detected 300 can be placed. However, the member on which the object to be detected 300 can be placed may be provided separately from the optical member. For example, the member on which the object to be detected 300 can be placed may be a plate-like member provided with a hole capable of accommodating the object to be detected 300. The arrangement of the light source panel 20 and the sensor panel 10 may be reversed. In that case, the member 60 is placed, for example, above the object to be detected 300 and between the object to be detected 300 and the sensor panel 10.

The object to be detected 300 includes a culture medium (e.g., agar) formed in a light-transmitting container, such as glass. In the culture medium, samples to be cultured, such as biological tissues or microorganisms, are cultured. The container is a Petri dish, for example, but is not limited thereto, and may have another configuration. For example, the container may be a plate for suspension culture or the like.

In FIG. 4, a housing 150 that supports the sensor panel 10 so as to position the sensor panel 10 below the member 60 is provided. The housing 150 supports the sensor panel 10 so as to form a space for providing the object to be detected 300 on the member 60 between the sensor panel 10 and the light source panel 20. The light source panel 20 is located above the sensor panel 10 with the member 60 interposed therebetween.

FIG. 5 is a block diagram illustrating a configuration example of the detection system 1. In the configuration illustrated in FIG. 5, a plurality of the MCUs 30 are coupled to the host computer 90 via the hub 110. The host computer 90 is an information processing device, such as a personal computer (PC). The host computer 90 includes an arithmetic processor 91, a storage 92, the USB host controller 93, an input device 94, the display 95, and a power supply 96.

The arithmetic processor 91 includes an arithmetic circuit that serves as a central processing unit (CPU). The arithmetic processor 91 reads data stored in the storage 92, reads computer programs and the like included in the data, and executes the computer programs and the like so as to perform various processes related to operations of the host computer 90. The "computer programs and the like" refers to software programs and data including information that is referenced when executing the software programs.

The storage 92 includes a storage device that stores therein the computer programs and the like. The storage device is a non-volatile storage device, such as a solid-state drive (SSD), a hard disk drive (HDD), or a flash memory. FIG. 5 illustrates application software 921 as the computer programs and the like stored by the storage 92. Functions of the host computer 90 implemented by executing the application software 921 will be described later.

The storage 92 includes a random-access memory (RAM) that serves as a storage area temporarily used during the execution by the arithmetic processor 91.

The USB host controller 93 is provided so as to be couplable to external equipment that operates as USB equipment. The arithmetic processor 91 of the host computer 90 executes the application software 921 to perform processing linked to the MCU 30 coupled to the USB host controller 93.

The input device 94 is provided so as to be capable of receiving input operations from outside to the host computer 90. The input device is configured with, for example, at least one or more of a keyboard, a mouse, and other devices, but are not limited to these devices. The input device may have other configurations, such as a touch panel provided to be integrated with the display 95, for example.

The display 95 provides a display output depending on the content of the processing by the arithmetic processor 91. The display 95 is, for example, a liquid crystal display, an organic electroluminescent (EL) display, or the like, but is not limited to these displays, and may be one that performs the display output by using another method.

The power supply 96 includes a power supply device that supplies power to the host computer 90 and external equipment coupled to the host computer 90. In the case of the configuration illustrated in FIG. 5, the host computer 90, the hub 110, the MCU 30, and the sensor panel 10 and the light source panel 20 coupled to the MCU 30 are operated by the power supplied from the power supply 96.

The hub 110 is a USB hub interposed between the host computer 90 and the MCU 30. The hub 110 includes an upstream USB port 111 and a plurality of downstream USB ports 112. The upstream USB port 111 is a USB port that is coupled to the USB host controller 93 of the host computer 90 via a USB cable. The downstream USB ports 112 are USB ports that are coupled to the USB ports 34 of the MCUs 30 via USB cables.

The MCU 30 includes an arithmetic circuit 31, a storage circuit 32, a control circuit 33, the USB port 34, and a buffer memory 35. Some of the components included in the MCU 30 may be integrated together. For example, the arithmetic circuit 31 and the buffer memory 35 may have a configuration provided in the same SoC (System on a Chip).

The arithmetic circuit 31 executes computer programs and the like stored in the storage circuit 32 and performs various processes related to operations of the MCU 30 and operations of the sensor panel 10 and the light source panel 20 that are coupled to the MCU 30.

The storage circuit 32 stores therein the computer programs and the like. FIG. 5 illustrates firmware 321 as the computer programs and the like stored by the storage circuit 32.

The control circuit 33 controls the operations of the sensor panel 10 and the light source panel 20 under the control of the arithmetic circuit 31 that is executing the firmware 321. Thus, the arithmetic circuit 31 and the control circuit 33 cooperate to serve as circuits that control the operations of the sensor panel 10 and the light source panel 20. The MCU 30 is coupled to the sensor panel 10 and the light source panel 20 via components, such as flexible printed circuits (FPCs), that include wiring.

The USB port 34 is a USB port for coupling to the host computer 90. A USB-based coupling path by the USB port 34 to the USB host controller 93 of the host computer 90 via the hub 110 serves as both a communication path between the MCU 30 and the host computer 90 and a power supply path from the host computer 90 to the MCU 30. That is, the power supply to the detection device 100 and the communication between the host computer 90 and the MCU 30 are performed via the USB-based coupling.

The buffer memory 35 is a storage circuit for temporarily storing imaging data by the output from the sensor panel 10, as buffer data.

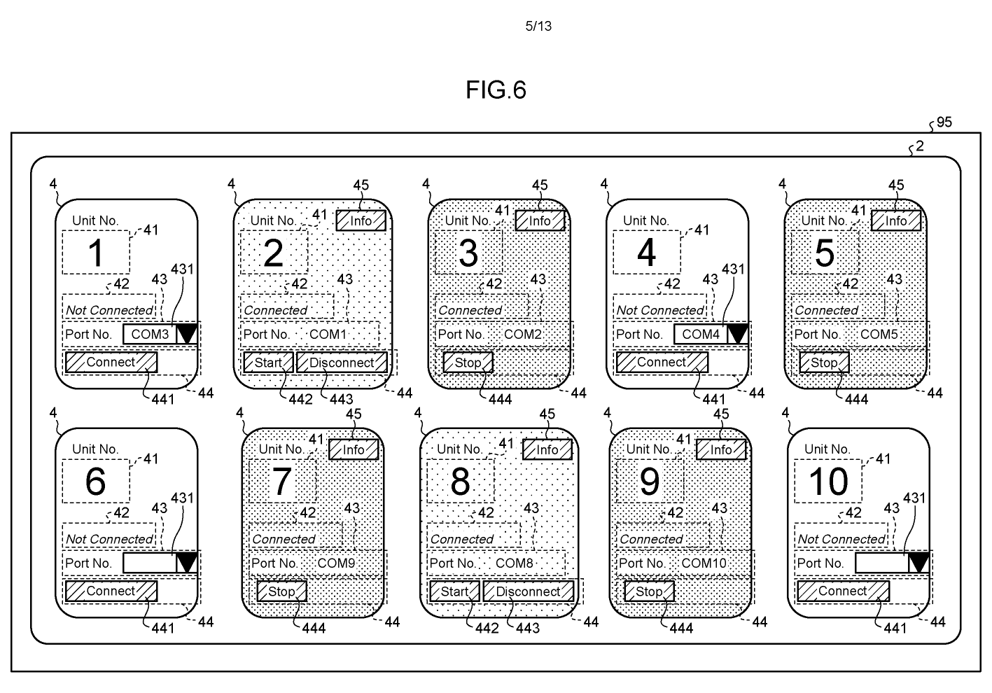

The hub 110 may be omitted. For example, the USB host controller 93 may be provided with a plurality of USB ports. In that case, the MCU 30 is individually coupled to each of the USB ports included in the USB host controller 93. The function of the hub 110 may be integrated into the USB host controller 93. The number of the MCUs 30 only needs to be greater than or equal to one, and need not be greater than one. The following description with reference to FIG. 6 assumes that ten MCUs 30 are coupled to the host computer 90.

FIG. 6 is a view illustrating an example of the display output provided by the display 95 of the host computer 90 executing the application software 921. The arithmetic processor 91 in the process of executing the application software 921 displays a large window 2 on the display 95. The large window 2 includes one or more small windows 4 in the display output. The small window 4 serves as an individual display area in which information on one detection device 100 is displayed. The number of the small windows 4 included in the large window 2 corresponds to the number of the MCUs 30 coupled to the host computer 90 via the hub 110. That is, one small window 4 is allocated to one of the MCUs 30. Information on one MCU 30 is displayed in one of the small windows 4. Hereinafter, when an explanation is made on the MCU 30 in connection with a description of the small window 4, the explanation is assumed to be regarding the MCU 30 to which the small window 4 is allocated. Each of the small windows 4 includes a unit number display area 41, a communication state display area 42, a port number display area 43, and a button display area 44.

The unit number display areas 41 are each an area where a number individually assigned to a corresponding one of the MCUs 30 is displayed. The function to assign the number displayed in the unit number display area 41 is a function performed by the host computer 90 through the execution of the application software 921.

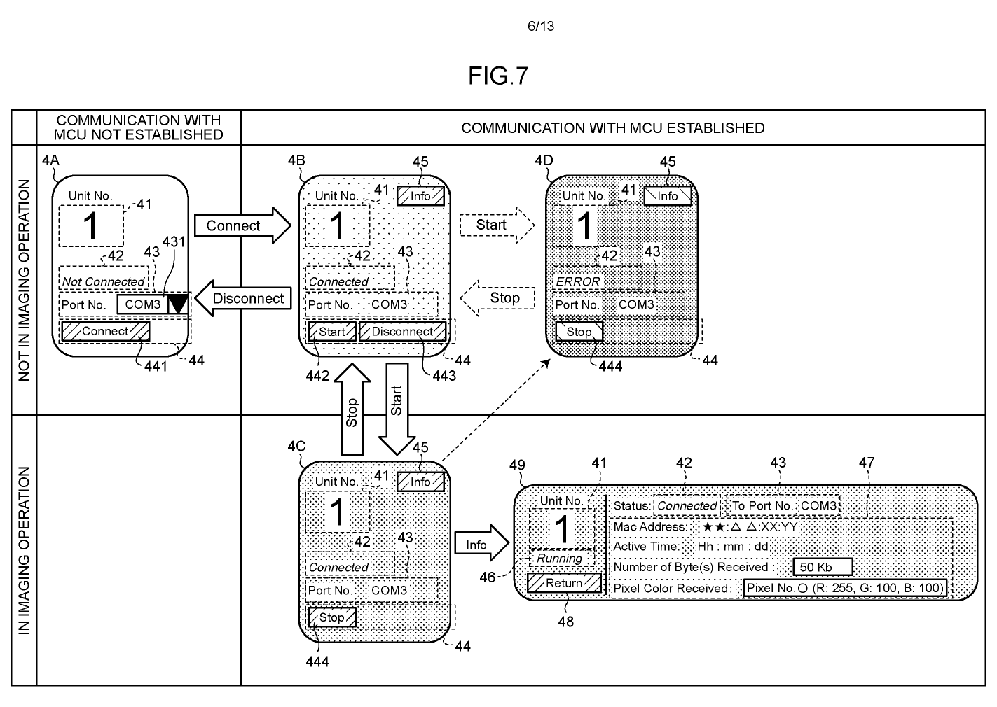

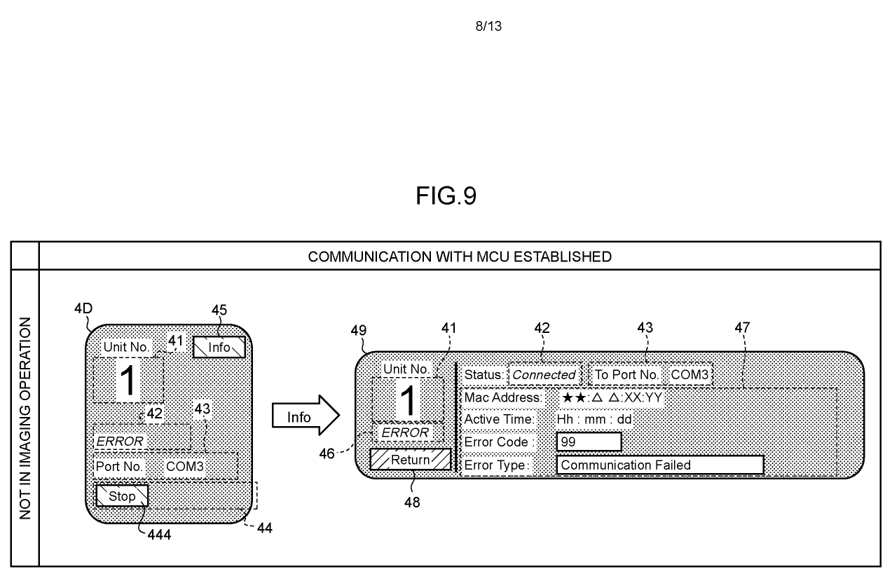

The communication state display area 42 is an area where information on the state of communication between the host computer 90 and the MCU 30 is displayed. If the communication between the host computer 90 and the MCU 30 is not established, a string "Not Connected" is displayed in the communication state display area 42. If the communication between the host computer 90 and the MCU 30 is established, a string "Connected" or a string "ERROR" (refer to FIGS. 7 and 9) is displayed in the communication state display area 42. Thus, the communication state display area 42 displays the information on whether the communication between the MCU 30 included in one detection device 100 and the host computer 90 via the USB-based coupling is established.

The port number display area 43 is an area where information on a port number assigned by the host computer 90 to the MCU 30 are displayed. If the communication between the host computer 90 and the MCU 30 is not established, a selection operation area 431 for selecting the port number to be assigned to the MCU 30 is displayed in the port number display area 43. If the communication between the host computer 90 and the MCU 30 is established, a string indicating the port number already assigned to the MCU 30 is displayed in the port number display area 43. For example, a string "COM1" displayed in the port number display area 43 indicates that a port with the number "1" (COM port) is assigned to the MCU 30.

The button display area 44 is an area where buttons corresponding to operations that can be performed on the MCU 30 are displayed. An "Info" button 45 may be displayed in the small window 4. Details of the button display area 44 and the "Info" button 45 will be described below with reference to FIG. 7.

FIG. 7 is a diagram illustrating transition of the display output of the small window 4 and an example of the display output of a detail window 49 that is displayed in response to an operation on the "Info" button 45 in an imaging operation state 4C. A disconnect state 4A, a standby state 4B, the imaging operation state 4C, and an error state 4D illustrated in FIG. 7 represent states that can be taken by the small window 4. In other words, the display output of the small window 4 corresponds to any one of the disconnect state 4A, the standby state 4B, the imaging operation state 4C, and the error state 4D. The number displayed in the small window 4 in the disconnect state 4A is not limited to "1" illustrated in FIG. 7, but is a number assigned to the MCU 30.

If the communication between the host computer 90 and the MCU 30 is not established, the display output of the small window 4 becomes the disconnect state 4A. In the disconnect state 4A, the string "Not Connected" is displayed in the communication state display area 42. In the disconnect state 4A, a "Connect" button 441 is displayed in the button display area 44. As described above, if the communication between the host computer 90 and the MCU 30 is not established, the selection operation area 431 is displayed in the port number display area 43. Therefore, in the disconnect state 4A, the selection operation area 431 is displayed in the port number display area 43. The port number to be assigned to the MCU 30 is selected by operation of the selection operation area 431 by an operator who operates the host computer 90. The operator is a human. Hereinafter, the term simply called "operator" refers to the operator who operates the host computer 90.

Port numbers that can be selected in the selection operation area 431 are port numbers that have not yet been assigned at that time. In FIG. 6, port numbers from 1 to 10 are provided in advance. The port number is represented by a number appended to the end of a string "COM", and in FIG. 6, ports numbered "1", "2", "5", "8", "9", and "10" have already been assigned. In this case, "3", "4", "6", or "7" can be selected by an operation on the selection operation area 431.

First, an operation by the operator brings the selection operation area 431 into a state where a port number to be assigned to the MCU 30 is selected. In this state, when the "Connect" button 441 is operated, the arithmetic processor 91 performs a process to establish the communication between the host computer 90 and the MCU 30. This process establishes the communication between the host computer 90 and the MCU 30, so that the display output of the small window 4 shifts from the disconnect state 4A to the standby state 4B. The port number assigned for the communication becomes the number selected in the selection operation area 431.

In the standby state 4B, the string "Connected" is displayed in the communication state display area 42. In the standby state 4B, a "Start" button 442 and a "Disconnect" button 443 are displayed in the button display area 44. The "Start" button 442 is a button for instructing starting an imaging operation. That is, when the "Start" button 442 is operated, both the sensor panel 10 and the light source panel 20 that are coupled to the MCU 30 start operating, and an imaging operation starts. If both the sensor panel 10 and the light source panel 20 coupled to the MCU 30 normally operate in response to the operation of the "Start" button 442, the display output of the small window 4 shifts from the standby state 4B to the imaging operation state 4C.

In the imaging operation state 4C, the string "Connected" is displayed in the communication state display area 42. In the imaging operation state 4C, a "Stop" button 444 is displayed in the button display area 44. The "Stop" button 444 is a button for instructing ending the imaging operation. That is, when the "Stop" button 444 is operated, both the sensor panel 10 and the light source panel 20 coupled to the MCU 30 stop operating, and the imaging operation ends.

Thus, each of the disconnect state 4A and the standby state 4B is the display output of the small window 4 when no imaging operation is being performed by the sensor panel 10 and the light source panel 20 coupled to the MCU 30. The imaging operation state 4C is the display output of the small window 4 when the imaging operation is being performed by the sensor panel 10 and the light source panel 20 coupled to the MCU 30. FIG. 7 illustrates these states as "Not in Imaging Operation" areas and "In Imaging Operation" areas.

The "Disconnect" button 443 displayed in the button display area 44 in the standby state 4B is a button for instructing operation of the host computer 90 to end the communication between the host computer 90 and the MCU 30, and bring the host computer 90 into the state where the communication is not established. When the "Disconnect" button 443 is operated, the arithmetic processor 91 performs a process to cancel the assignment of the port to the MCU 30 and disconnect the communication between the host computer 90 and the MCU 30. Since this process disconnects the communication between the host computer 90 and the MCU 30, the display output of the small window 4 shifts from the standby state 4B to the disconnect state 4A.

The imaging operation by the sensor panel 10 and the light source panel 20 that are coupled to the MCU 30 may not be performed normally for some reason. The host computer 90 determines whether the imaging operation is performed normally, based on whether the data obtained by the imaging operation is normally transmitted from the MCU 30 to the host computer 90. If the data obtained by the imaging operation is not normally transmitted from the MCU 30 to the host computer 90 even after the "Start" button 442 is operated in the standby state 4B, the display output of the small window 4 shifts from the standby state 4B to the error state 4D. Even once the display output of the small window 4 is brought into the imaging operation state 4C, if the data obtained by the imaging operation becomes not normally transmitted from the MCU 30 to the host computer 90, the display output of the small window 4 shifts from the imaging operation state 4C to the error state 4D. Therefore, the error state 4D is the display output of the small window 4 when the imaging operation is not performed by the sensor panel 10 and the light source panel 20 coupled to the MCU 30 in the imaging operation state 4C.

In the error state 4D, the string "ERROR" is displayed in the communication state display area 42. In the error state 4D, the "Stop" button 444 is displayed in the button display area 44. When the "Stop" button 444 is operated in the error state 4D, the imaging operation is forcibly ended regardless of the operational state of the sensor panel 10 and the light source panel 20 coupled to the MCU 30. As a result, the display output of the small window 4 shifts from the error state 4D to the standby state 4B.

As illustrated as "Communication with MCU Not Established" areas and "Communication with MCU Established" areas in FIG. 7, the disconnect state 4A is the display output of the small window 4 when the communication between the host computer 90 and the MCU 30 is not established. The standby state 4B, the imaging operation state 4C, and the error state 4D are each the display output of the small window 4 when the communication between the host computer 90 and the MCU 30 is not established. If the communication between the host computer 90 and the MCU 30 is established, the "Info" button 45 is further displayed, in addition to the unit number display area 41, the communication state display area 42, the port number display area 43, and the button display area 44.

The "Info" button 45 is a button for displaying the detail window 49 as a separate pop-up window. When the "Info" button 45 is operated, the arithmetic processor 91 displays the detail window 49 as a separate pop-up window in the large window 2.

The detail window 49 includes the unit number display area 41, the communication state display area 42, the port number display area 43, an operation state display area 46, a device information display area 47, and a display end button display area 48. The display output of the unit number display area 41 in the detail window 49 is the same as the display output of the unit number display area 41 in the small window 4 in which the "Info" button 45 operated for the display of the detail window 49 has been displayed. Unless otherwise noted, the display output of the communication state display area 42 in the detail window 49 is the same as the display output of the communication state display area 42 in the small window 4 in which the "Info" button 45 operated for the display of the detail window 49 has been displayed. The display output of the port number display area 43 in the detail window 49 is the same as the display output of the port number display area 43 in the small window 4 in which the "Info" button 45 operated for the display of the detail window 49 has been displayed. FIG. 7 illustrates the detail window 49 when the "Info" button 45 is operated in the imaging operation state 4C. The display outputs of the unit number display area 41, the communication state display area 42, and the port number display area 43 of the detail window 49 are the same as those of the unit number display area 41, the communication state display area 42, and the port number display area 43 in the imaging operation state 4C.

The operation state display area 46 is an area where a string indicating the operation state of the sensor panel 10 and the light source panel 20 coupled to the MCU 30 is displayed. In the detail window 49 when the "Info" button 45 is operated in the imaging operation state 4C, a string "Running" is displayed in the operation state display area 46. The string "Running" indicates that operation states of the sensor panel 10 and the light source panel 20 coupled to the MCU 30 are normal imaging operation states.

The device information display area 47 is an area where a media access control (MAC) address of the MCU 30, an active time of the MCU 30, and other information are displayed. The media access control (MAC) address of the MCU 30 is displayed in a "Mac Address" area. The active time of the MCU 30 is displayed in an "Active Time" area.

The other information includes information on an amount of buffer data transmitted from the MCU 30 and information indicated by the latest buffer data, in the detail window 49 when the "Info" button 45 is operated in the imaging operation state 4C. The amount of buffer data transmitted from the MCU 30 is displayed in a "Number of Byte(s) Received" area. The information indicated by the latest buffer data is displayed in a "Pixel Color Received" area. The amount of buffer data, herein, is the amount of one of a plurality of divided pieces of the buffer data for a process at Step S63 to be described later.

The display end button display area 48 is an area where a "Return" button is displayed. The "Return" button is a button used for ending the display of the detail window 49. When the display end button display area 48 is operated, the pop-up display of the detail window 49 including the display end button display area 48 ends.

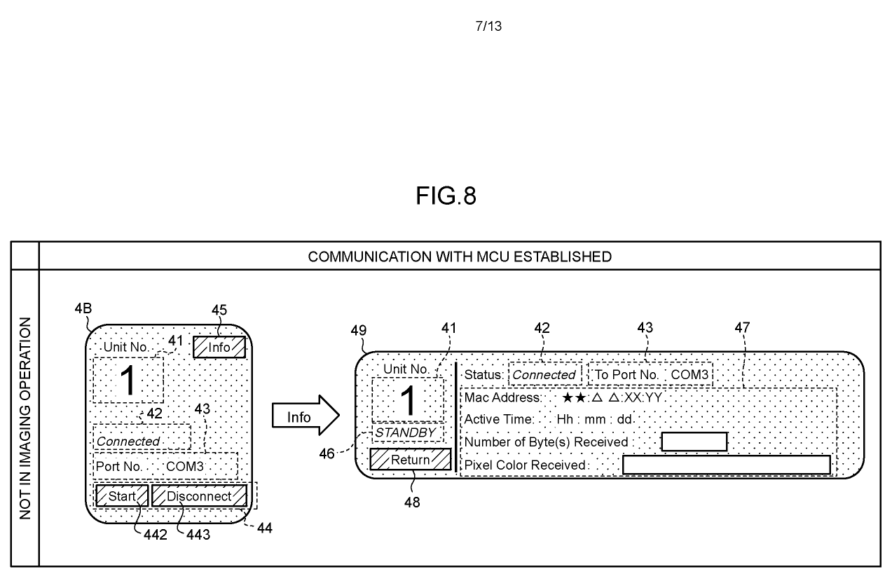

FIG. 8 is a diagram illustrating the display output in the standby state 4B and an example of the display output of the detail window 49 that is displayed in response to the operation on the "Info" button 45 in the standby state 4B. In the detail window 49 when the "Info" button 45 is operated in the standby state 4B, a string "STANDBY" is displayed in the operation state display area 46. The string "STANDBY" indicates that the sensor panel 10 and the light source panel 20 coupled to the MCU 30 are in a state of waiting for the start of the imaging operation.

The detail window 49 when the "Info" button 45 is operated in the standby state 4B differs from the detail window 49 when the "Info" button 45 is operated in the imaging operation state 4C in that the other information in the device information display area 47 becomes an empty area. Except for the above noted matter, the detail window 49 when the "Info" button 45 is operated in the standby state 4B is the same as the detail window 49 when the "Info" button 45 is operated in the imaging operation state 4C.

FIG. 9 is a diagram illustrating the display output in the error state 4D and an example of the display output of the detail window 49 that is displayed in response to the operation on the "Info" button 45 in the error state 4D. In the detail window 49 when the "Info" button 45 is operated in the error state 4D, the string "Connected" is displayed in the communication state display area 42. This string indicates that the communication between the host computer 90 and the MCU 30 is established.

In the detail window 49 when the "Info" button 45 is operated in the error state 4D, the string "ERROR" is displayed in the operation state display area 46. The string "ERROR" indicates that the sensor panel 10 and the light source panel 20 coupled to the MCU 30 are in the error state of not performing the normal imaging operations.

In the detail window 49 when the "Info" button 45 is operated in the error state 4D, the other information in the device information display area 47 is replaced with information indicating the type of the error and the content of the error. The information indicating the type of the error is displayed in an "Error Code" area. The information indicating the content of the error is displayed in an "Error Type" area. Except for the above noted matter, the detail window 49 when the "Info" button 45 is operated in the error state 4D is the same as the detail window 49 when the "Info" button 45 is operated in the imaging operation state 4C.

As described with reference to FIGS. 6 to 8, the display output of the detail window 49 includes the information indicating the operation state of the detection device 100. The detail window 49 is displayed by operating the "Info" button 45, as described above. If the communication is established between the host computer 90 and the MCU 30, the "Info" button 45 is displayed in the small window 4. Therefore, in the detection system 1, when the communication is established between the MCU 30 and the host computer 90, the information indicating the operation state of one detection device 100 including the MCU 30 can be further displayed.

In addition, in the embodiment, the information on the detection device 100 to which the small window 4 is assigned is displayed also by a background color of the small window 4. Specifically, in the embodiment, the background color becomes white in the disconnect state 4A. The background color becomes light green in the standby state 4B. The background color becomes orange in the imaging operation state 4C. The background color becomes purple in the error state 4D. In FIG. 6, the differences in background color among the disconnect state 4A, the standby state 4B, the imaging operation state 4C, and the error state 4D are indicated by differences in dot pattern. The operator can obtain the information on the detection device 100 based on the differences in background color among the disconnect state 4A, the standby state 4B, the imaging operation state 4C, and the error state 4D.

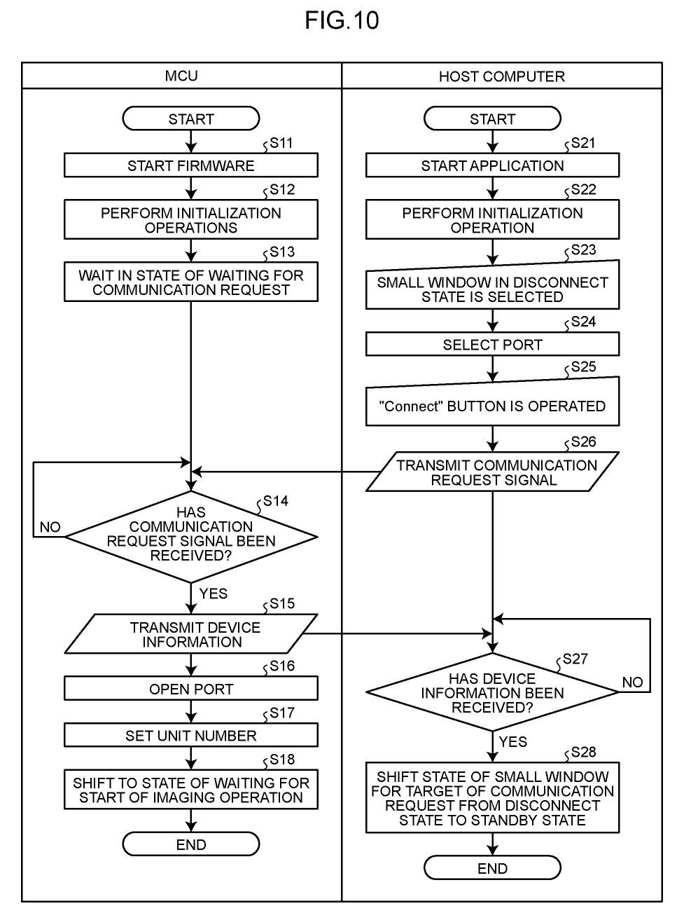

The following describes a relation between processing performed by the host computer 90 and processing performed by the MCU 30, with reference to flowcharts in FIGS. 10 to 14.

FIG. 10 is a flowchart of processing performed since the host computer 90 and the MCU 30 start operating until the communication is established between the host computer 90 and the MCU 30.

In the MCU 30, the arithmetic circuit 31 reads out the firmware 321 from the storage circuit 32 and executes the firmware 321, thereby starting the firmware 321 (Step S11). After the process at Step S11, first, initialization operations of the MCU 30, and the sensor panel 10 and the light source panel 20 coupled to the MCU 30 are performed (Step S12). After the process at Step S12 is completed, the arithmetic circuit 31 waits in a state of waiting for a communication request from the host computer 90 (Step S13).

Meanwhile, in the host computer 90, the arithmetic processor 91 reads out the application software 921 from the storage 92 and executes the application software 921, thereby starting the application software 921 (Step S21). The "app" refers to the application software 921. After the process at Step S11, first, an initialization operation of each part of the host computer 90 is performed (Step S22). After the process at Step S22, the arithmetic processor 91 displays the large window 2 on the display 95 (refer to FIG. 6), and waits in a state of waiting for an input operation via the input device 94. At this point, the display outputs of all the small windows 4 included in the large window 2 are in the disconnect state 4A. That is, the communication between the host computer 90 and the MCU 30 is not established.

Then, the operator selects any one of the small windows 4 that are in the disconnect state 4A, that is, that indicate that the communication is not established (Step S23). The operator selects a port number by operating the selection operation area 431 displayed in the port number display area 43 of the small window 4 selected in the process at Step S23 (Step S24). Then, when the "Connect" button 441 displayed in the button display area 44 of the small window 4 selected in the process at Step S23 is operated (Step S25), the arithmetic processor 91 transmits a communication request signal to the MCU 30 corresponding to the port number selected in the process at Step S24 (Step S26). The communication request signal is transmitted via the USB-based coupling. The communication request signal is accompanied by information indicating a number displayed in the small window 4 in the disconnect state 4A selected in the process at Step S23.

While waiting in the process at Step S13, that is, while waiting in the state of waiting for the communication request from the host computer 90, the arithmetic circuit 31 of the MCU 30 waits until receiving the communication request signal transmitted by the process at Step S26 (No at Step S14). During the waiting, if the communication request signal transmitted by the process at Step S26 is received (Yes at Step S14), the arithmetic circuit 31 transmits device information to the host computer 90 via the USB-based coupling (Step S15). The device information is, for example, the MAC address or the like, and is registered in advance in the MCU 30.

After the process at Step S15, the arithmetic circuit 31 opens a port to be used in the communication made via the USB-based coupling (Step S16). The arithmetic circuit 31 also sets a number associated with the communication request signal transmitted by the process at Step S26 as a unit number assigned by the host computer 90 (Step S17). The arithmetic circuit 31 shifts to the state of waiting for the start of the imaging operation (Step S18). In the state of waiting for the start of the imaging operation, the sensor panel 10 and the light source panel 20 coupled to the MCU 30 including the arithmetic circuit 31 wait in the state of waiting for the start of the imaging operation.

Meanwhile, the arithmetic processor 91 of the host computer 90 waits until receiving the device information from the MCU 30 after the process at Step S26 (No at Step S27). If the device information is received from the MCU 30 (Yes at Step S27), the arithmetic processor 91 performs a process to shift the display output of the small window 4 selected in the process at Step S23 from the disconnect state 4A to the standby state 4B (Step S28).

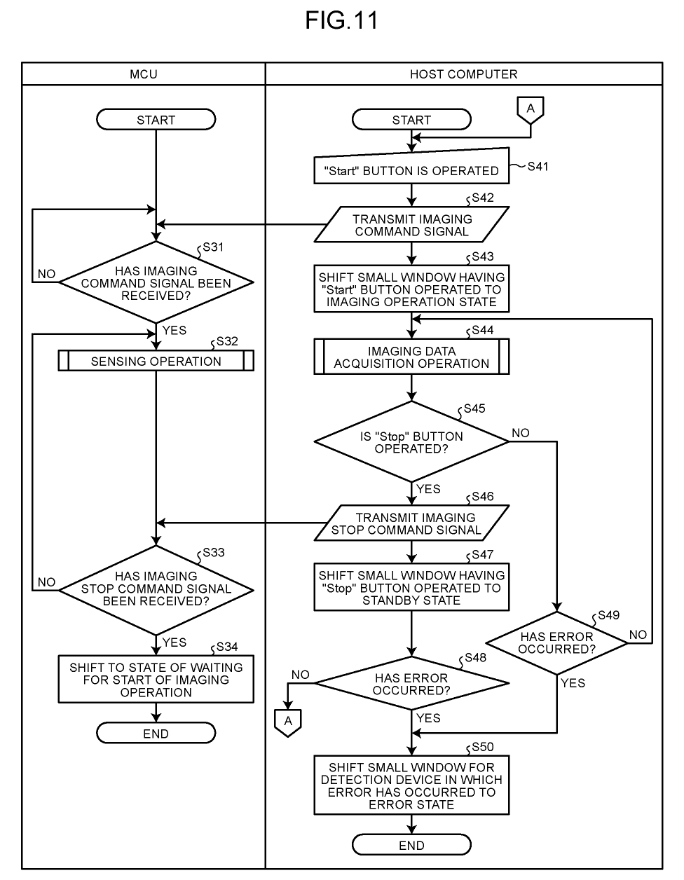

FIG. 11 is a flowchart of processing performed in response to the operation on the "Start" button 442 while the communication is established between the host computer 90 and the MCU 30. When the "Start" button 442 displayed in the button display area 44 of the standby state 4B is operated by the operator (Step S41), the arithmetic processor 91 transmits an imaging command signal to the MCU 30 for which the same number as that displayed in the unit number display area 41 of the standby state 4B is set as the unit number in the process at Step S17 (refer to FIG. 10) (Step S42). The arithmetic processor 91 also performs a process to shift the display output of the small window 4 having the "Start" button 442 operated at Step S41 from the standby state 4B to the imaging operation state 4C (Step S43). After the process at Step S43, the host computer 90 performs an imaging data acquisition operation (Step S44).

Meanwhile, the MCU 30 waits in the state of waiting for the start of the imaging operation caused by the process at Step S18 (refer to FIG. 10), until receiving the imaging command signal transmitted from the host computer 90 in the process at Step S42 (No at Step S31). If the imaging command signal is received (Yes at Step S31), the MCU 30 performs a sensing operation (Step S32). The imaging data acquisition operation at Step S44 by the host computer 90 and the sensing operation at Step S32 by the MCU 30 are performed in parallel.

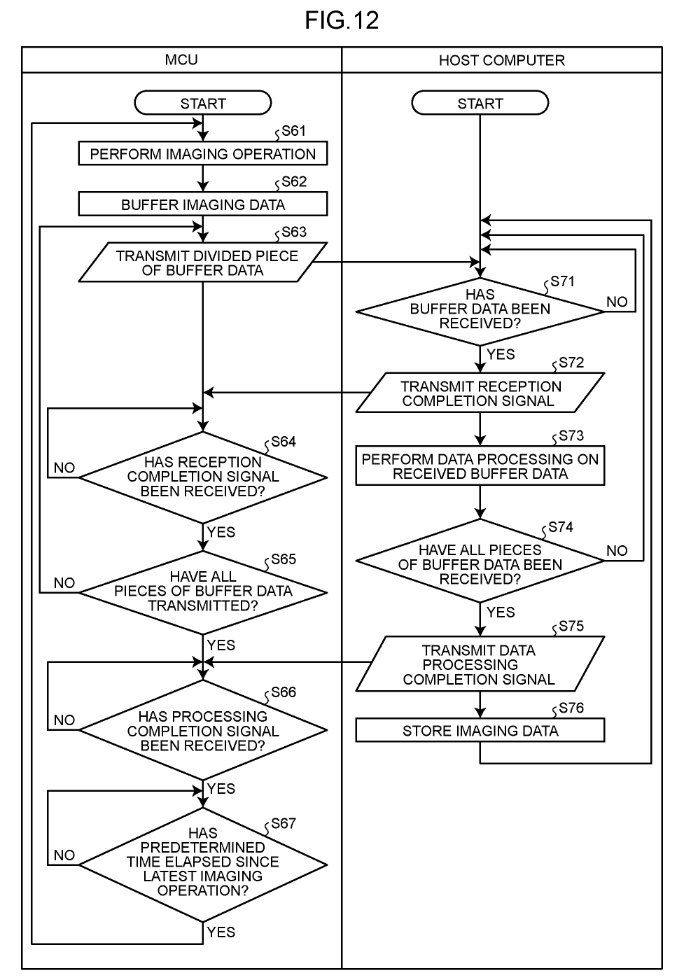

FIG. 12 is a flowchart of the sensing operation performed by the MCU 30 and the imaging data acquisition operation performed by the host computer 90. That is, the flowchart illustrated in FIG. 12 illustrates the sensing operation in an "MCU" area and the imaging data acquisition operation in a "Host Computer" area. In the sensing operation performed by the MCU 30, the imaging operation is performed first (Step S61). That is, the light sources 22 of the light source panel 20 are turned on, and the sensor panel 10 detects the light that has passed through the object to be detected 300. Then, the output of the sensor panel 10 indicating the intensity of the detected light is generated. The arithmetic circuit 31 acquires the output of the sensor panel 10 obtained in the process at Step S61 as the imaging data and buffers it in the buffer memory 35 (Step S62). Hereinafter, the "buffer data" refers to the data buffered in the buffer memory 35 in the process at Step S62. The arithmetic circuit 31 divides the buffer data into multiple pieces each of which has a size smaller than the total size of the imaging data. The arithmetic circuit 31 transmits one of the divided pieces of the buffer data to the host computer 90 (Step S63).

The total size of the imaging data is one megabytes, for example, but is not limited thereto. The total size of the imaging data is determined in advance according to various factors, such as the number of the optical sensors WA provided on the sensor panel 10, the bit depth of each of the optical sensors WA, and the color depth of the imaging data. The size of the buffer data to be transmitted each time the process at Step S63 is performed, that is, the amount of the one of the divided pieces of the buffer data, is 50 bytes, for example, but is not limited thereto. The size of the buffer data to be transmitted each time the process at Step S63 is performed is determined in advance according to the bit rate of the communication between the host computer 90 and the MCU 30, the information processing capability of the host computer 90, the information processing capability of the MCU 30, and other factors.

Meanwhile, in the imaging data acquisition operation performed by the host computer 90, the arithmetic processor 91 waits until receiving the divided piece of the buffer data transmitted from the MCU 30 in the process at Step S63 (No at Step S71). If the divided piece of the buffer data is received (Yes at Step S71), the arithmetic processor 91 transmits a reception completion signal to the MCU 30 that has transmitted the divided piece of the buffer data in the process at Step S63 (Step S72).

After the process at Step S63, the arithmetic circuit 31 waits until receiving the reception completion signal transmitted from the host computer 90 in the process at Step S72 (No at Step S64). If the reception completion signal is received (Yes at Step S64), the arithmetic circuit 31 checks whether all pieces of the buffer data buffered in the process at Step S62 have been transmitted (Step S65). That is, the arithmetic circuit 31 checks whether all the divided pieces of the buffer data have been transmitted. If not all pieces of the buffer data buffered in the process at Step S62 have been transmitted (No at Step S65), the process moves to Step S63. That is, the arithmetic circuit 31 transmits, to the host computer 90, one of the divided pieces of the buffer data that has not yet been transmitted.

Meanwhile, the arithmetic processor 91 performs data processing on the received buffer data after the process at Step S72 (Step S73). Specifically, in the process at Step S73, the arithmetic processor 91 performs a process to restore the original imaging data before division, such as a process to combine the received data among the divided pieces of the buffer data. The arithmetic processor 91 also checks whether all pieces of the buffer data corresponding to one piece of the imaging data have been received (Step S74). If not all pieces of the buffer data corresponding to one imaging data have been received (No at Step S74), the process moves to Step S71. That is, the arithmetic processor 91 shifts to the waiting state for receiving data that has not yet been received among the divided pieces of the buffer data.

If it is determined in the process at Step S74 that all pieces of the buffer data corresponding to the one imaging data have been received (Yes at Step S74), the arithmetic processor 91 transmits a data processing completion signal (Step S75). The data processing completion signal is transmitted to the MCU 30 that has transmitted the divided pieces of the buffer data in the process at Step S63. Performing the process at Step S75 means that the one imaging data has been obtained by the data processing on the received buffer data in the latest process at Step S73. The arithmetic processor 91 stores the one imaging data obtained by the process at Step S73 in the storage 92 (Step S76). Thus, in the imaging data acquisition operation performed by the host computer 90, the host computer 90 performs the process to sequentially receive the buffer data transmitted from the MCU 30 and store the received buffer data as the imaging data. After the process at Step S76, the process moves to Step S71.

If all the divided pieces of the buffer data have been transmitted from the MCU 30 to the host computer 90 in the process at Step S65 (Yes at Step S65), the arithmetic circuit 31 waits until receiving the data processing completion signal (No at Step S66). The data processing completion signal is the data processing completion signal transmitted from the host computer 90 in the process at Step S75. If the data processing completion signal is received (Yes at Step S66), the arithmetic circuit 31 waits until a predetermined time elapses since the latest imaging operation (No at Step S67). The "latest imaging operation" herein refers to the latest process at Step S61.

After the process at Step S66, when the predetermined time has elapsed since the latest imaging operation (Yes at Step S67), the process moves to Step S61. That is, the imaging operation performed by the MCU 30 is repeated in a cycle of the predetermined time until an imaging operation stop signal, which will be described later, is received. The imaging data acquisition operation performed by the host computer 90 is also repeated in accordance with the repetition of the imaging operation performed by the MCU 30.

In other words, the sensing operation that is the process at Step S32 is an operation that repeats, in a cycle of the predetermined time, the imaging operation that is the process at Step S61. The imaging operation is started with the imaging command signal transmitted from the host computer 90 to the detection device 100 in the process at Step S42. The imaging command signal is transmitted by operating the "Info" button 45 in the standby state 4B. Therefore, the "Info" button 45 serving as a button that enables an input operation to transmit the imaging command signal to the host computer 90 is displayed in the small window 4 where the display output is in the standby state 4B. The imaging command signal is transmitted to the MCU 30 that has transmitted the device information in the process at Step S15 in response to the communication request signal transmitted by the process at Step S26. The control circuit 33 of the MCU 30 that has received the imaging command signal performs the imaging operation under the control of the arithmetic circuit 31. In the imaging operation, the sensor panel 10 and the light source panel 20 are operated to cause the sensor panel 10 to detect the light from the light sources 22. The arithmetic circuit 31 transmits the imaging data given by the output from the sensor panel 10 produced in accordance with the imaging operation, to the host computer 90 via the USB-based coupling.

The predetermined time in the process at Step S67 is five minutes, for example, but is not limited thereto, and may be any time. The predetermined time is preferably a time during which the processes from Step S61 to Step S66 can be sufficiently performed.

During the operation at Step S44 in FIG. 11, that is, during the imaging data acquisition operation by the host computer 90, the arithmetic processor 91 continues the operation at Step S44 as long as no interruption occurs. The phrase "no interruption occurs" refers to that the "Stop" button 444 is not operated in the imaging operation state 4C (No at Step S45) and no error related to the communication with the MCU 30 occurs during the sensing operation (No at Step S49). If the "Stop" button 444 in the small window 4 is operated during the operation at Step S44 (Yes at Step S45), the arithmetic processor 91 transmits an imaging stop command signal to the MCU 30 corresponding to the small window 4 (Step S46). The arithmetic processor 91 also performs a process to shift the display output of the small window 4 having the "Stop" button 444 operated, from the imaging operation state 4C to the standby state 4B (Step S47).

The sensing operation at Step S32 is continued until the MCU 30 receives the imaging stop command signal (No at Step S33). If the imaging stop command signal transmitted in the process at Step S46 by the host computer 90 is received (Yes at Step S33), the arithmetic circuit 31 shifts to the state of waiting for the start of the imaging operation (Step S34).

While the display output of the small window 4 is in the standby state 4B, the standby state continues while being ready to shift to Step S41 as long as no error related to the communication with the MCU 30 corresponding to the small window 4 occurs (No at Step S48). However, if an error related to the communication with the MCU 30 occurs (Yes at Step S48), the arithmetic processor 91 performs a process to shift, to the error state 4D, the display output of the small window 4 corresponding to the detection device 100 including the MCU 30 in which the error has occurred (Step S50). During the operation at Step S44, even if the "Stop" button 444 is not operated (No at Step S45), the arithmetic processor 91 performs the process at Step S50 when an error related to the communication with the MCU 30 during the imaging operation occurs (Yes at Step S49).

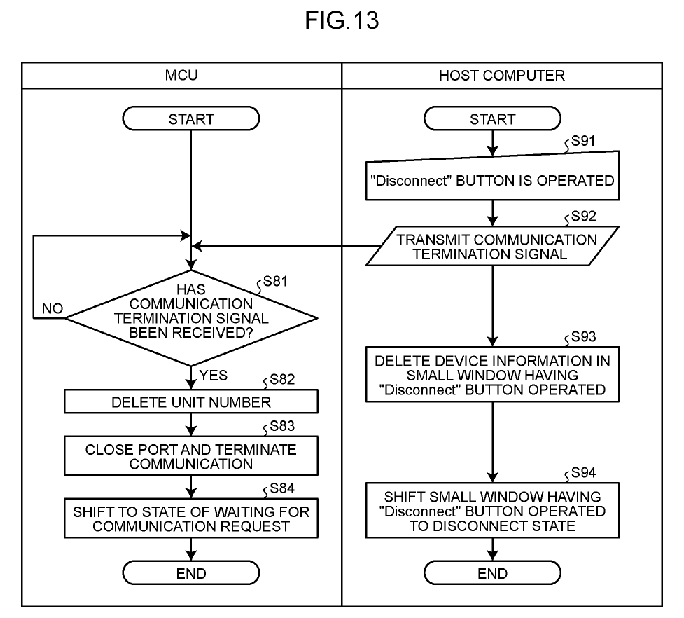

FIG. 13 is a flowchart of processing performed in response to the operation on the "Disconnect" button 443 while the communication is established between the host computer 90 and the MCU 30. When the "Disconnect" button 443 is operated by the operator (Step S91), the arithmetic processor 91 transmits a communication termination signal to the MCU 30 (Step S92). The arithmetic processor 91 also deletes the device information of the MCU 30 having the "Disconnect" button 443 operated (Step S93). The arithmetic processor 91 also performs a process to shift the display output of the small window 4 having the "Disconnect" button 443 operated at Step S91, from the standby state 4B to the disconnect state 4A (Step S94).

Meanwhile, if the communication termination signal is received (Yes at Step S81), the arithmetic circuit 31 of the MCU 30 deletes the unit number set in the process at Step S17 (Step S82). The arithmetic circuit 31 also performs a process to close the port opened in the process at Step S16 and terminate the communication through the port (Step S83). Then, the arithmetic circuit 31 shifts to the state of waiting for the communication request (Step S84). In other words, the processes from Step S82 to Step S84 are not performed unless the communication termination signal is received (No at Step S81).

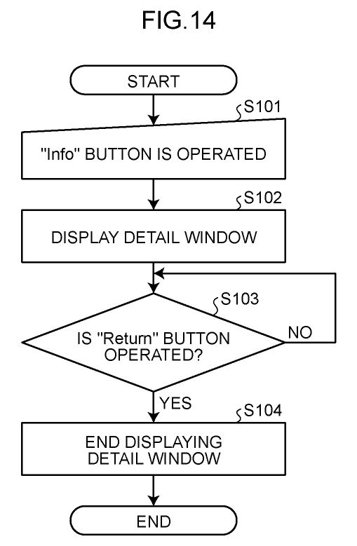

FIG. 14 is a flowchart illustrating processing performed in response to the operation on the "Info" button 45 while the communication is established between the host computer 90 and the MCU 30. The processing illustrated by the flowchart in FIG. 14 is performed by the host computer 90.

When the "Info" button 45 is operated by the operator in any one of the standby state 4B, the imaging operation state 4C, and the error state 4D (Step S101), the arithmetic processor 91 performs a process to display the detail window 49 (Step S102). The detail window 49 displayed in the process at Step S102 corresponds to the display output of the small window 4 having the "Info" button 45 operated in the process at Step S101. Specifically, if the "Info" button 45 is operated in the standby state 4B, the detail window 49 described with reference to FIG. 8 is displayed. If the "Info" button 45 is operated in the imaging operation state 4C, the detail window 49 described with reference to FIG. 7 is displayed. If the "Info" button 45 is operated in the error state 4D, the detail window 49 described with reference to FIG. 9 is displayed.

The detail window 49 continues to be displayed until the display end button ("Return") display area 48 included in the detail window 49 displayed in the process at Step S102 is operated (No at Step S103). When the display end button display area 48 is operated (Yes at Step S103), the arithmetic processor 91 performs a process to end displaying the detail window 49 displayed in the process at Step S102 (Step S104).

According to the embodiment described above, the detection system (detection system 1) includes the detection device (detection device 100) and the information processing device (host computer 90). The detection device includes a sensor panel (sensor panel 10) on which a plurality of optical sensors (optical sensors WA) are two-dimensionally arranged, a light source panel (light source panel 20) on which light sources (light sources 22) that emit light are provided, an object placement member (member 60) provided to enable an object to be detected (object to be detected 300) to be placed thereon so that the object to be detected is interposed between the sensor panel and the light source panel, and a controller (MCU 30) provided with a circuit (arithmetic circuit 31) that is coupled to the sensor panel and the light source panel and controls operations of the sensor panel and the light source panel. The controller is coupled to the information processing device via the USB. The power supply to the detection device and the communication between the information processing device and the controller are performed via the USB-based coupling. These couplings allow the USB cable (USB cable 39) to serve as both a cable for supplying power to operate the detection device and a cable for communication between the information processing device and the controller. Therefore, the form of cables provided for the detection device can be simplified compared with a configuration in which a power line is independent from a communication line.

The information processing device (host computer 90) sends the imaging command signal to the controller (MCU 30) via the USB-based coupling. The circuit (arithmetic circuit 31) of the controller operates the sensor panel and the light source panel (light source panel 20) so as to perform the imaging operation of causing the sensor panel (sensor panel 10) to detect the light from the light sources (light sources 22) in a cycle of a predetermined time, and transmits the imaging data given by the output from the sensor panel produced in response to the imaging operation to the information processing device via the USB-based coupling. Through these operations, the imaging operation is performed in a cycle of the predetermined time while the object to be detected (object to be detected 300) is placed on the object placement member (member 60). As a result, the imaging data reflecting a degree to which the object to be detected transmits light can be obtained in a cycle of the predetermined time. Therefore, by operating the detection system (detection system 1), the imaging data that reflects changes in the culture medium that occur as the progression of growth of the samples to be cultured can be obtained in a cycle of the predetermined time. Based on the imaging data, the progression of growth of the samples to be cultured can be checked from the imaging data.

The detection system (detection system 1) includes a plurality of the detection devices (detection devices 100), and the controller (MCU 30) of each of the detection devices is coupled to the information processing device (host computer 90) via the USB. Thus, the USB cable (USB cable 39) can also serve as cables for supplying power to operate a plurality of the detection devices and cables for communication between the information processing device and the controllers. Therefore, the form of cables provided for the detection devices can be simplified compared with a configuration in which power lines and communication lines are independent from one another.

The information processing device (host computer 90) includes a display (display 95). The display displays a plurality of individual display areas (small windows 4) in each of which information on one of the detection devices (detection devices 100) is displayed. The number of the individual display areas corresponds to the number of the detection devices. In each of the individual display areas, information on whether the communication is established between the controller (MCU 30) included in one of the detection devices (detection devices 100) and the information processing device via the USB-based coupling is displayed (communication state display area 42), and when the communication is established, information indicating the operation state of the one detection device can be further displayed (such as the detail window 49). These features allow the information processing device to communicate with each of the detection devices and check the operation state of each of the detection devices. Furthermore, the detection devices need not each be provided with a dedicated communication port. Therefore, the controller can be made more compact and less expensive.

The information processing device (host computer 90) transmits the communication request signal to the controller (MCU 30) via the USB-based coupling. The controller transmits the device information to the information processing device via the USB-based coupling in response to the communication request signal. The imaging command signal is transmitted to the controller that has transmitted the device information in response to the communication request signal. Through these operations, the communication between the information processing device and the detection device can be established by the communication request signal before transmitting the imaging command signal for causing the detection device (detection device 100) to perform the imaging operation in a cycle of the predetermined time.

The information processing device (host computer 90) includes the display (display 95). The display displays the individual display areas (small windows 4) in which information on the detection devices (detection devices 100) is displayed. The information processing device brings, into the standby state, the individual display area assigned to the detection device (detection device 100) including the "controller (MCU 30) that has transmitted the device information in response to the communication request signal", and displays the button ("Start" button 442) that allows an input operation to be made to transmit the imaging command signal to the information processing device in the individual display area in the standby state (standby state 4B). These features can provide a mechanism that allows determination of "any detection device to which the imaging command signal is to be transmitted and any transmission timing of the imaging command signal".

The switching elements 81 and 85 illustrated in FIG. 3 are each not limited to the configuration with a single switching element. For example, at least one of the switching elements 81 and 85 may have what is called a double-gate configuration.

The arrangement of the optical sensors WA is not limited to the matrix having a row-column configuration along the first direction Dx and the second direction Dy. For example, the optical sensors WA arranged in each of the sensor rows adjacent in the second direction Dy need not be located in a straight line along the second direction Dy. Specifically, the arrangement may be what is called a staggered arrangement. From the viewpoint of sharing the reset signal transmission line 5 and the scan line 6, the arrangement of the optical sensors WA along the first direction Dx is preferably an arrangement located in a straight line along the first direction Dx, but this is not necessary. The arrangement of the optical sensors WA along the first direction Dx can be changed within a scope not degrading the function of the optical sensors WA and the detection area SA. The arrangement of the light sources 22 on the light source panel 20 is also not limited to the matrix, and can be any arrangement, such as what is called a staggered arrangement.

Other operational advantages accruing from the aspects described in the present embodiment that are obvious from the description herein, or that are conceivable as appropriate by those skilled in the art will naturally be understood as accruing from the present disclosure.

What is claimed is:

1. A detection system comprising a detection device and an information processing device,
wherein the detection device comprises:
a sensor panel on which a plurality of optical sensors are two-dimensionally arranged;
a light source panel provided with a light source configured to emit light;
an object placement member provided to enable an object to be detected to be placed thereon so that the object to be detected is interposed between the sensor panel and the light source panel; and
a controller provided with a circuit that is coupled to the sensor panel and the light source panel, and configured to control operations of the sensor panel and the light source panel,
wherein the controller is coupled to the information processing device via a Universal Serial Bus (USB) (registered trademark), and
wherein power supply to the detection device and communication between the information processing device and the controller are performed via a coupling based on the USB.

2. The detection system according to claim 1,
wherein the information processing device is configured to transmit an imaging command signal to the controller via the coupling based on the USB, and
wherein the circuit is configured to operate the sensor panel and the light source panel so as to perform an imaging operation of causing the sensor panel to detect the light from the light source in a cycle of a predetermined time, and transmit imaging data given by an output from the sensor panel produced in response to the imaging operation to the information processing device via the coupling based on the USB.

3. The detection system according to claim 1, comprising a plurality of the detection devices,
wherein the controller of each of the detection devices is coupled to the information processing device via the coupling based on the USB.

4. The detection system according to claim 3,
wherein the information processing device comprises a display,
wherein the display is configured to display a plurality of individual display areas in each of which information on one of the detection devices is displayed,
wherein the number of the individual display areas corresponds to the number of the detection devices, and
wherein in each of the individual display areas, information on whether the communication is established between the controller included in one of the detection devices and the information processing device via the coupling based on the USB is displayed, and when the communication is established, information indicating an operation state of the one detection device is allowed to be further displayed.

5. The detection system according to claim 2,
wherein the information processing device is configured to transmit a communication request signal to the controller via the coupling based on the USB,
wherein the controller is configured to transmit device information to the information processing device via the coupling based on the USB in response to the communication request signal, and
wherein the imaging command signal is transmitted to the controller that has transmitted the device information in response to the communication request signal.

6. The detection system according to claim 5,
wherein the information processing device comprises a display,
wherein the display is configured to display an individual display area in which information on the detection device is displayed, and
wherein the information processing device is configured to:
bring, into a standby state, the individual display area assigned to the detection device comprising the controller that has transmitted the device information in response to the communication request signal, and
display a button that allows an input operation to be made to transmit the imaging command signal to the information processing device in the individual display area in the standby state.
